(19) United States
(12) Patent Application Publication
(10) Pub. No.: US 2015/0206102 A1
(43) Pub. Date: Jul. 23, 2015

(54) Human Resource Analytics Engine with Multiple Data Sources

(71) Applicant: International Business Machines Corporation, Armonk, NY (US)

(72) Inventors: Karl J. Cama, Coppell, TX (US); Norbert Herman, Denver, CO (US); Daniel T. Lambert, New York, NY (US)

(73) Assignee: International Business Machines Corporation, Armonk, NY (US)

(21) Appl. No.: 14/159,906

(22) Filed: Jan. 21, 2014

(51) Int. Cl. G06Q 10/10

(52) U.S. Cl. CPC G06Q 10/1053

(57) ABSTRACT

The disclosure is directed to a human resource (HR) analytics engine. A method in accordance with an embodiment includes: filtering data related to a job candidate from a plurality of internal and external data sources using a plurality of ingestion engines; generating a composite profile for the job candidate using the filtered data output from each of the plurality of ingestion engines; and mapping the composite profile for each job candidate against a personnel matrix to determine if the job candidate is a potential match for a job.

### TECHNICAL FIELD

The present invention relates generally to data analysis, and more particularly, to a human resource (HR) analytics engine with multiple data sources.

### RELATED ART

HR departments commonly rely on management reports, peer ratings, interviews, and subjective sources to make hiring and firing decisions. In general, HR departments have limited tooling and analytical resources to make fully educated decisions about potential resource actions.

### SUMMARY

The HR analytics engine of the present invention improves placement decisions (e.g., new hire, reassignment) in an organization by creating a composite profile of a job candidate based on multiple internal and external data sources. The composite profile can be used as a supplement to the interview process. The composite profile of a job candidate is compared to previously generated profiles of top performers in one or more positions within the organization or within a particular field.

A first aspect of the invention provides a method for data analysis, comprising: filtering data related to a job candidate from a plurality of internal and external data sources using a plurality of ingestion engines; generating a composite profile for the job candidate using the filtered data output from each of the plurality of ingestion engines; and mapping the composite profile for each job candidate against a personnel matrix to determine if the job candidate is a potential match for a job.

A second aspect of the invention provides an HR analytics engine configured to perform a method, the method comprising: filtering data related to a job candidate from a plurality of internal and external data sources using a plurality of ingestion engines; generating a composite profile for the job candidate using the filtered data output from each of the plurality of ingestion engines; and mapping the composite profile for each job candidate against a personnel matrix to determine if the job candidate is a potential match for a job.

A third aspect of the invention provides a computer program product including program code embodied in at least one computer-readable hardware storage device, which when executed, enables a computer system to implement a method for data analysis, the method comprising: filtering data related to a job candidate from a plurality of internal and external data sources using a plurality of ingestion engines; generating a composite profile for the job candidate using the filtered data output from each of the plurality of ingestion engines; and mapping the composite profile for each job candidate against a personnel matrix to determine if the job candidate is a potential match for a job.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an HR analytics engine according to embodiments.

FIG. 2 depicts a flow diagram of a process according to embodiments.

FIG. 3 shows an illustrative environment for providing an HR analytics engine according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION

The present invention relates generally to data analysis, and more particularly, to a human resource (HR) analytics engine with multiple data sources.

The HR analytics engine of the present invention improves placement decisions (e.g., new hire, reassignment) in an organization by creating a composite profile of a job candidate based on multiple internal and external data sources. The composite profile can be used as a supplement to the interview process. The composite profile of a job candidate is compared to previously generated profiles of high performers in one or more positions within the organization or within a particular field.

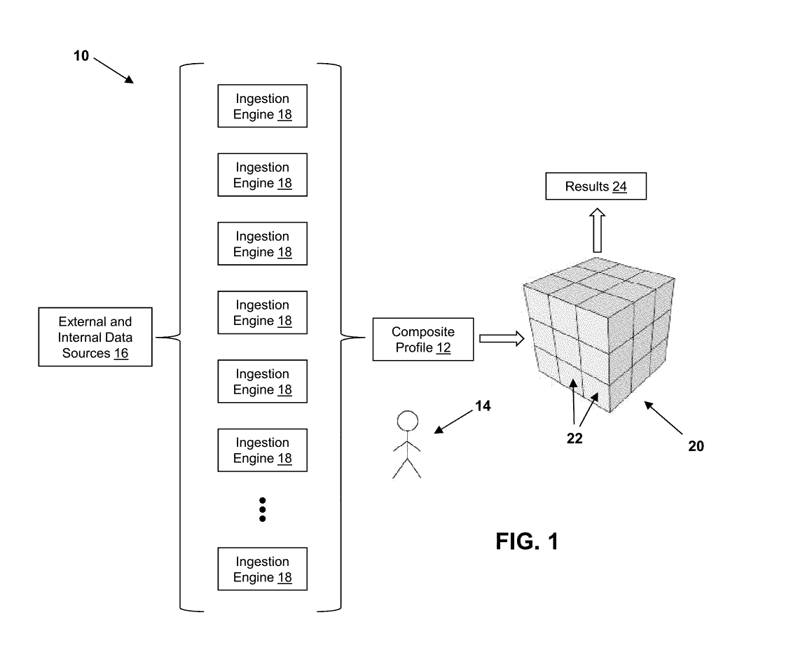

An HR analytics engine 10 according to embodiments is depicted in FIG. 1. The HR analytics engine 10 is configured to generate a composite profile 12 of a job candidate 14 for one or more jobs in an organization based on multiple internal and external data sources 16.

The HR analytics engine 10 includes a plurality of ingestion engines 18 that are configured to filter data from the internal and external data sources 16 and output a composite profile 12 of the job candidate 14. The composite profile 12 of the job candidate 14 is fed into a personnel matrix 20 (shown as a data cube in this embodiment) and mapped against HR metrics 22 related to other individuals, including top performers, in one or more jobs and/or fields. As known in the art, such a data cube is a type of multidimensional matrix that lets users explore and analyze a collection of data from many different perspectives. Based on the comparison, the HR analytics engine 10 determines whether the job candidate 14 is a good match for one or more jobs in the organization and outputs the results 24 of the comparison.

The personnel matrix 20 can be loaded with HR metrics 22 corresponding to other individuals, including top performers, in one or more jobs and/or fields. To this extent, the desired HR metrics 22 for one or more jobs and/or fields can be determined, aggregated, and stored in the personnel matrix 20.

The ingestion engines 18 are configured to cull massive amounts of data from a plurality of internal and external data sources 16. External data sources may include any source of data available on the Internet that is associated in some way with the job candidate. This may include, for example, social media activity on Facebook, Twitter, LinkedIn, Reddit, etc., as well as blog contributions, video uploads/downloads, comments made on websites or in response to articles, visited web pages, and/or the like.

One or more of the ingestion engines 18 may be configured to process data from external data sources for psycholinguistic profiling. For example, the job candidate 14 can be measured on personality traits such as aggressiveness, empathy, ego, negativeness, forthrightness, and/or the like. For instance, a job candidate 14 who communicates primarily in the first person may be considered more forthright than someone who communicates in a mixture of the first/third person. A job candidate 14 who commonly uses a phrase such as “that stinks” rather than a phrase such as “that is a terrible situation,” may be considered to be overly negative and to have unsophisticated language skills. Different job roles inherently require different personality styles, and one or more of the ingestion engines 18 can be used to determine a person's proclivity to perform at a certain job.

The psycholinguistic profiling may also include, for example, examining the data from external data sources to establish a colloquial score using factors such as sentence structure, punctuation, and word complexity. A job candidate 14 with a higher colloquial score may be considered as having better writing and communication skills than lower scoring job candidates 14.

One or more of the ingestion engines 18 may also be configured to examine data from external sources for disparaging (and/or positive) comments by the job candidate 14 about an individual, service, or previous employer. One or more of the ingestion engines 18 may also be configured to screen for inappropriate material that may be counter to an organization's culture or standards.

A job candidate's sphere of influence in certain fields may also be determined by one or more of the ingestion engines 18. For example, a Klout score related to a technology field such as integrated circuits may be extremely important to a manager with hiring responsibilities in the semi-conductor industry.

For a job candidate 14 seeking a different position or promotion within an organization, or looking to be rehired by an organization, at least one ingestion engine 18 may be provided to automatically comb through internal data (e.g., historical reports, reviews, etc.) within the organization. For example, some organizations maintain a large amount of qualitative information for each former and current employee that can be mined for psycholinguistic insights and composite numerical scoring on personality dimensions and performance dimensions.

Deep personal structured data may also be analyzed by one or more of the ingestion engines 18. This data may include, for example, address history, income history, purchasing history, approximate wealth, and many other personal details. This data can be used in a number or ways, including detecting resume fraud via location matching and any income reporting.

One or more of the ingestion engines 18 may also examine internal and/or external data regarding salary and compensation. Using this data, an optimal compensation package for a job and a specific job candidate can be generated.

The ingestion engines 18 output a composite profile 12 of the job candidate 14, which is fed into a personnel matrix 20 and mapped against HR metrics 22 related to other individuals, including top performers, in one or more jobs and/or fields. The personnel matrix 20 can then be transformed into matches for specific jobs. In other words, if implemented as a data cube, the personnel matrix 20 can be “spun” in a known manner to identify the desired characteristics of current top performers in, for example, a particular job in an organization. The criteria of those top performers can then be leveraged to re-spin the personnel matrix 20 to find additional potential candidates.

The composite profile 12 of a job candidate 14 is compared to the desired characteristics of high performers in one or more positions within the organization or within a particular field. Based on the degree of matching, a job candidate 14 may be considered a good match for one or more positions within the organization.

Algorithms such as Knn—nearest neighbor algorithm may be used to identify top performers, and potentially identify similar candidates. The HR analytics engine 10 has the ability to learn new patterns of performing individuals across different roles and this learning may be verified and refined with HR human expertise for even better patterns. This may be a major benefit for organizations that are constantly reshuffling employees to new assignments to meet market needs. Typically, a resource action will create many free employees, while at the same time there are many free job openings. A significant cost savings related to hiring and firing may be achieved using the HR analytics engine 10 of the present invention to match the free employees to the free job openings.

Considering that job candidates 14 are normally weighted by similarity (GPA or programming skills, languages, tools, etc.), a request can be issued to the Knn algorithm to insatiate the object initially requested by the organization. If the request returns multiple job candidates 14, i.e., by more than one neighbor, the nearest neighbors can be hierarchically evaluated.

Strategic differentiation can be used for effectively breaking ties (e.g., assuming 2 or more job candidates 14 are identified as being close matches). For example, if a job being applied for has a creative element to it, which requires thinking out of the box and working in the abstract, the best job candidate 14 may not be the one that scored the highest on a measured test or personality profile, but the one that has hobbies in music, creative art or painting. A request can be made to determine which of the matching job candidates 14 is more “creative,” based on comments, views, opinions, etc., of other human beings. To this extent, one or more of the ingestion engines 18 may be configured to ingest and examine external data related to the creative abilities of the job candidates 14. As an example, a job candidate 14 may have had an exhibition at a local art gallery and received critical acclaim on social media or online reviews for their original work, technique, level of detail, etc.

The Knn—nearest neighbor algorithm and scoring technique allows additional filters to be introduced that focus on attributes that go beyond those listed in a resume or those which may be uncovered in a structured test or personality based interview.

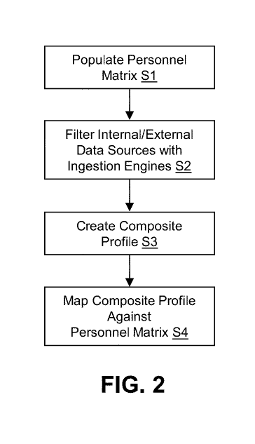

FIG. 2 depicts a flow diagram of a process according to embodiments.

At S1, a personnel matrix is populated with HR metrics related to individuals, including top performers, in one or more jobs and/or fields. The personnel matrix can be updated as necessary to reflect, for example, changes to the HR metrics related to one or more individuals, changes to job requirements, etc. At S2, a plurality of ingestion engines filter data related to one or more job candidates from numerous internal and external data sources. At S3, a composite profile is created for each job candidate using the filtered data output from each of the plurality of ingestion engines. At S4, the composite profile for each job candidate is mapped against the HR metrics in the personnel matrix to identify potential candidates (and/or highest scoring candidates) for one or more jobs. The mapping result can be used to supplement a standard interview process.

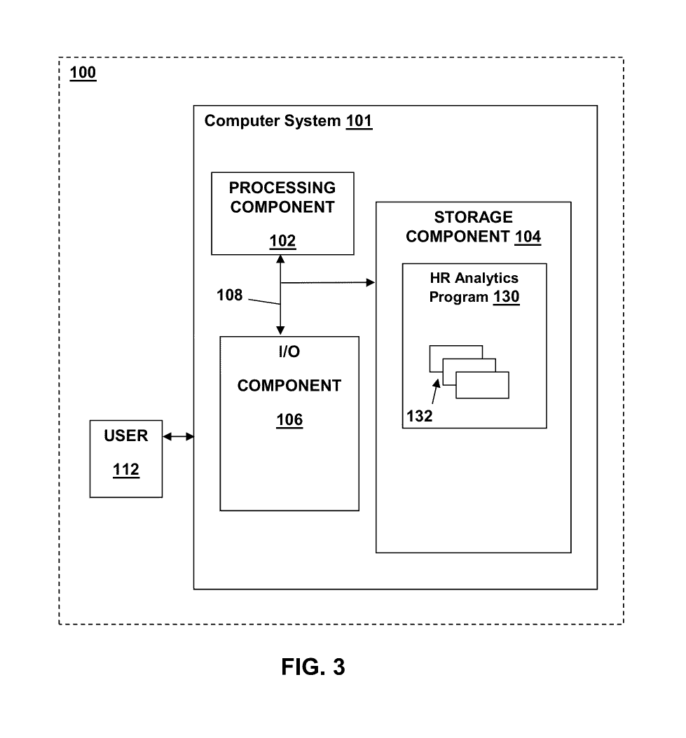

An illustrative environment 100 for providing an HR analytics engine is shown in FIG. 3. The environment 100 includes at least one computer system 101 and an HR analytics program 130 that can perform the processes described herein to implement the HR analytics engine 10.

The computer system 101 is shown including a processing component 102 (e.g., one or more processors), a storage component 104 (e.g., a storage hierarchy), an input/output (I/O) component 106 (e.g., one or more I/O interfaces and/or devices), and a communications pathway 108. In general, the processing component 102 executes program code, such as the HR analytics program 130, which is at least partially fixed in the storage component 104. While executing program code, the processing component 102 can process data, which can result in reading and/or writing transformed data from/to the storage component 104 and/or the I/O component 106 for further processing. The pathway 108 provides a communications link between each of the components in the computer system 101. The I/O component 106 can include one or more human I/O devices, which enable a human user 112 to interact with the computer system 101 and/or one or more communications devices to enable a system user 112 to communicate with the computer system 101 using any type of communications link. To this extent, the HR analytics program 130 can manage a set of interfaces (e.g., graphical user interface(s), application program interfaces, communication interface(s), and/or the like) that enable human and/or system users 112 to interact with the HR analytics program 130. Furthermore, the HR analytics program 130 can manage (e.g., store, retrieve, create, manipulate, organize, present, etc.) the data using any solution.

The computer system 101 can include one or more general purpose computing articles of manufacture (e.g., computing devices) capable of executing program code, such as the HR analytics program 130, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the HR analytics program 130 can be embodied as any combination of system software and/or application software.

Furthermore, the HR analytics program 130 can be implemented using a set of modules 132. In this case, a module 132 can enable the computer system 20 to perform a set of tasks used by the HR analytics program 130, and can be separately developed and/or implemented apart from other portions of the HR analytics program 130. As used herein, the term “component” means any configuration of hardware, with or without software, which implements the functionality described in conjunction therewith using any solution, while the term “module” means program code that enables a computer system 101 to implement the actions described in conjunction therewith using any solution. When fixed in a storage component 104 of a computer system 101 that includes a processing component 102, a module is a portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 101.

When the computer system 101 includes multiple computing devices, each computing device can have only a portion of the HR analytics program 130 fixed thereon (e.g., one or more modules 132). However, it is understood that the computer system 101 and the HR analytics program 130 are only representative of various possible equivalent computer systems that may perform a process described herein. To this extent, in other embodiments, the functionality provided by the computer system 101 and the HR analytics program 130 can be at least partially implemented by one or more computing devices that include any combination of general and/or specific purpose hardware with or without program code. In each embodiment, the hardware and program code, if included, can be created using standard engineering and programming techniques, respectively.

When the computer system 101 includes multiple computing devices, the computing devices can communicate over any type of communications link. Furthermore, while performing a process described herein, the computer system 101 can communicate with one or more other computer systems using any type of communications link. In either case, the communications link can include any combination of various types of optical fiber, wired, and/or wireless links; include any combination of one or more types of networks; and/or utilize any combination of various types of transmission techniques and protocols.

While shown and described herein as a method and system for detecting illegal activity through interpersonal relationship resolution, it is understood that aspects of the invention further provide various alternative embodiments. For example, in one embodiment, the invention provides a computer program fixed in at least one computer-readable storage medium, which when executed, enables a computer system to for detect illegal activity through interpersonal relationship resolution. To this extent, the computer-readable storage medium includes program code, such as the HR analytics program 130, which enables a computer system to implement some or all of a process described herein. It is understood that the term “computer-readable storage medium” includes one or more of any type of tangible medium of expression, now known or later developed, from which a copy of the program code can be perceived, reproduced, or otherwise communicated by a computing device. For example, the computer-readable medium can include: one or more portable storage articles of manufacture; one or more memory/storage components of a computing device; paper; and/or the like.

Another embodiment of the invention provides a method of providing a copy of program code, such as HR analytics program 130, which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

Still another embodiment of the invention provides a method for providing an HR analytics engine. In this case, a computer system, such as the computer system 101, can be obtained (e.g., created, maintained, made available, etc.) and one or more components for performing process(es) described herein can be obtained (e.g., created, purchased, used, modified, etc.) and deployed to the computer system. To this extent, the deployment can include one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A method for data analysis, comprising:
filtering data related to a job candidate from a plurality of internal and external data sources using a plurality of ingestion engines;
generating a composite profile for the job candidate using the filtered data output from each of the plurality of ingestion engines; and
mapping the composite profile for each job candidate against a personnel matrix to determine if the job candidate is a potential match for a job.

2. The method of claim 1, wherein the personnel matrix is populated with metrics related to top performers in one or more jobs or fields.

3. The method of claim 1, wherein at least one of the plurality of ingestion engines filters data associated with the job candidate from social media activity.

4. The method of claim 1, wherein at least one of the plurality of ingestion engines processes data associated with the job candidate for psycholinguistic profiling.

5. The method of claim 4, wherein the psycholinguistic profiling includes determining a colloquial score for the job candidate.

6. The method of claim 4, wherein the psycholinguistic profiling includes determining personality traits of the job candidate.

7. The method of claim 1, wherein at least one of the plurality of ingestion engines processes data associated with the job candidate for disparaging or positive comments made by the job candidate regarding an individual, service, or previous employer.

8. The method of claim 1, wherein at least one of the plurality of ingestion engines processes data associated with the job candidate to determine a sphere of influence of the job applicant in at least one field.

9. The method of claim 1, wherein the job candidate was previously employed by an organization, and wherein at least one of the plurality of ingestion engines processes internal organization data associated with the job candidate to determine at least one of psycholinguistic, personality, and performance data for the job candidate.

10. A human resource (HR) analytics engine configured to perform a method, the method comprising:
filtering data related to a job candidate from a plurality of internal and external data sources using a plurality of ingestion engines;
generating a composite profile for the job candidate using the filtered data output from each of the plurality of ingestion engines; and
mapping the composite profile for each job candidate against a personnel matrix to determine if the job candidate is a potential match for a job.

11. The HR analytics engine of claim 10, wherein the personnel matrix is populated with metrics related to top performers in one or more jobs or fields.

12. The HR analytics engine of claim 10, wherein at least one of the plurality of ingestion engines filters data associated with the job candidate from social media activity.

13. The HR analytics engine of claim 10, wherein at least one of the plurality of ingestion engines processes data associated with the job candidate for psycholinguistic profiling.

14. The HR analytics engine of claim 13, wherein the psycholinguistic profiling includes determining a colloquial score for the job candidate.

15. The HR analytics engine of claim 13, wherein the psycholinguistic profiling includes determining personality traits of the job candidate.

16. The HR analytics engine of claim 10, wherein at least one of the plurality of ingestion engines processes data associated with the job candidate for disparaging or positive comments made by the job candidate regarding an individual, service, or previous employer.

17. The HR analytics engine of claim 10, wherein at least one of the plurality of ingestion engines processes data associated with the job candidate to determine a sphere of influence of the job applicant in at least one field.

18. The HR analytics engine of claim 10, wherein the job candidate was previously employed by an organization, and wherein at least one of the plurality of ingestion engines processes internal organization data associated with the job candidate to determine at least one of psycholinguistic, personality, and performance data for the job candidate.

19. A computer program product including program code embodied in at least one computer-readable hardware storage device, which when executed, enables a computer system to implement a method for data analysis, the method comprising:
filtering data related to a job candidate from a plurality of internal and external data sources using a plurality of ingestion engines;
generating a composite profile for the job candidate using the filtered data output from each of the plurality of ingestion engines; and
mapping the composite profile for each job candidate against a personnel matrix to determine if the job candidate is a potential match for a job.
